(19) United States
(12) Patent Application Publication
(10) Pub. No.: US 2005/0109213 A1
(43) Pub. Date: May 26, 2005

(54) Disposable coffee maker

(75) Inventor: Masaki Terada, Ibo-gun (JP)

Correspondence Address: KOPPEL, JACOBS, PATRICK & HEYBL, 555 ST. CHARLES DRIVE, SUITE 107, THOUSAND OAKS, CA, 91360, US

(73) Assignee: SRD Pharmaceuticals, Inc.

(21) Appl. No.: 10/982,058

(22) Filed: Nov. 5, 2004

(30) Foreign Application Priority Data
Nov. 20, 2003 (JP) 2003-431307

(51) Int. Cl. A47J 31/00

(52) U.S. Cl. 99/279

(57) ABSTRACT

A disposable coffee pot includes a lower section containing water which is heated by an external heat source. Pre-packaged ground coffee beans are located in either the lower section or in a central section isolated from the water until the temperature of the water is elevated. When the bottom of the coffee pot is heated by a heat source, the water is allowed to boil increasing the pressure in the lower section causing that boiling water to rise out of the lower section. The hot water also ruptures a container for the ground coffee beans, or a valve separating the water from the coffee beans, to allow the hot water to contact the beans and form a coffee extract. The coffee is extracted and then accumulated in an upper section through a pipe so that it is possible to collect and drink the coffee from the upper section.

This application claims the benefit of Japanese Patent Application Serial No. 2003-431307 filed Nov. 20, 2003.

### FIELD OF THE INVENTION

The present invention relates to a disposable coffee maker which stores coffee and water in a single container with a functional structure for preservation and transportation of the contents and is capable of readily making espresso coffee or percolator coffee by simply heating water stored in the coffee maker using a heat source outside of the container.

### BACKGROUND

In order to prepare espresso coffee or percolator coffee in the field or in a short period of time, dried, powdered coffee extract, or instant espresso coffee may be dissolved in hot water. However, in this case, water and a heat source are required.

Of course, cans and bottles filled with prepared espresso coffee or percolator coffee, that is, canned coffee and bottled coffee, are available from vending machines that warm the coffee. However, the coffee becomes cold as time passes. For this reason, methods for heating the coffee have been devised. For example, a method in which a heat generator is attached to the inside of the can has been disclosed. For example, the heat source of this type is applied to canned sake and is commercially available, the heat source can be utilized as it is.

Moreover, methods relating to instruments that warm the can from outside have been disclosed in various patent applications (see JP-A 62-23634 (1987), JP-A 05-294369 (1993), JP-A 05-305032 (1993), JP-A 08-282357 (1996), JP-A 11-332750 (1999) and JP-A 2003-504285).

Flavor is an important factor in coffee beverages, and the main objective of the above-mentioned instant coffee and canned coffee is how to provide coffee that maintains the inherent flavor. However, there is a clear distinction from fresh brewed coffee.

A solution to the problem with flavor is provided by a method disclosed in some patent documents in which normal ground coffee beans are put in a small bag or a container which is housed in a single container together with water. The water is heated through various methods and coffee is made by using the hot water (see JP-A 09-124078 (1997), JP-A 09-322856 (1997), JP-A 2000-238797 and JP-A 2001-253473). Since this method of making coffee is closer to the fresh brewed coffee, the resulting coffee is superior in terms of flavor in comparison with the above-mentioned instant coffee and canned coffee. However, this method is still unsatisfactory from the standpoint of time, task and flavor.

Patents JP-A 09-124078 (1997), JP-A 09-322856 (1997), JP-A 2000-238797 and JP-A 2001-253473 disclose a method in which normal ground coffee beans are stored in a single container together with water to make coffee by using these methods and from the viewpoint of flavor this method provides coffee that is superior to instant coffee, canned coffee, and bottled coffee. However this method still has problems.

JP-A 09-124078 (1997) has an arrangement in that the main body of the can is filled with water, and ground coffee beans, tea, green tea or the like is packed in a can smaller than the main body of the can, and the smaller can is housed in the main body so as to be preserved. To make coffee, the water is heated (boiled) and the small can is perforated to infiltrate the boiling water into the ground coffee beans, tea or green tea. When the hole is small, the ground coffee beans are not released into the can main body but the coffee extract is released into the can main body. However, this method is not different from a method in which coffee, tea or green tea stored in a small bag is immersed into hot water in a cup, that is, a tea-bag system, and this method fails to sufficiently extract coffee. Further, the resulting coffee is inferior in flavor in comparison with coffee that is made by existing espresso or percolator methods, that is, an extraction method using steam and boiling water.

JP-A 09-322856 (1997) and JP-A 2001-253473 have disclosed methods in which a set of utensils and materials required for making coffee is stored in only one can, and the same time and tasks are consequently required for making coffee.

JP-A 2000-238797 has disclosed a method in which coffee, tea or juice is stored in an olefin-based plastic bag in a manner so as to be separated from water by using an easily-separable melt-adhesion unit such as hot-melt, adhesive, heat-sealing, etc. and, upon preparation, the easily-separable melt-adhesion unit is broken so as to mix the two components. In this preparation method since only the water is used or heated, the corresponding coffee, tea or juice needs to be prepared as preliminarily extracted powder, that is, instant coffee or tea. Since this method is not applicable to ground coffee beams, its flavor is inferior to that made through the standard method.

This method is not different from the conventional drip method in which ground coffee beans placed into a small bag are preserved and, upon preparation, the small bag is opened and hot water is poured over the ground beans. Although this method is superior in flavor, the disadvantage of this method is that time-consuming tasks are required.

As described above, these methods are completely different from the existing method for making coffee in the espresso or percolator coffee system, are not satisfactory in flavor, and require time-consuming tasks. The present invention has been devised to address these disadvantages.

### SUMMARY OF THE INVENTION

The present invention provides a novel disposable coffee maker of espresso type or a percolator type that is different from those of conventional products. Coffee and water are placed into a single can that has a structure similar to a standard coffee maker, in a manner in which it can be preserved for a long time. To make coffee, it is only necessary to heat the stored water from the outside of the can, so that the water boils. The steam pressure generated causes the boiling water to automatically infiltrate into the ground coffee beans stored in the unit, or in the case of ground coffee beans packaged into a container that is breakable through heat, and the contents are exposed to the boiling water. The grounds are filtered and the coffee is then extracted and collected in a cup. With this arrangement, it becomes possible to prepare espresso-type or percolator-type coffee that is similar in flavor to coffee made through the current methods, without the necessity of time-consuming tasks and in a short period of time.

### BRIEF DESCRIPTION OF THE DRAWINGS

FIG. 1 is a partial cross-sectional view that shows the entire espresso-type disposable coffee maker in accordance with a first embodiment;

FIG. 2 is a cross-sectional view taken along line A-A of FIG. 1;

FIG. 3 is an enlarged cross-sectional view taken along the circled portion of FIG. 2 showing a film valve 10 and a boiling water transmission pipe 8;

FIG. 4 shows the circled portion of FIG. 2 with the film valve 10 opened by boiling water;

FIG. 5 is an enlarged cross-sectional view which shows another embodiment of the film valve 10 in the circled portion of FIG. 2;

FIG. 6 shows a cross-sectional view taken along line B-B of FIG. 5;

FIG. 7 shows the film valve opened by boiling water;

FIGS. 8, 9 and 10 are enlarged cross-sectional views each showing additional embodiments of the film valve 10 of FIG. 1 and the boiling water transmission pipe 8;

FIGS. 11 and 12 are partial cross-sectional views that show the water tank of an espresso-type disposable coffee maker in accordance with a second embodiment;

FIG. 13 shows another embodiment of the water tank 18 of FIG. 11;

FIG. 14 shows still another embodiment of the espresso-type disposable coffee maker in which extracted coffee is directed to a separate cup;

FIGS. 15 and 16 show further embodiments of the ground coffee retainer portion;

FIG. 17 shows another embodiment of the coffee retaining portion of FIG. 14;

FIGS. 18 and 19 show a modified version of FIG. 14;

FIGS. 20, 21, and 22 are cross-sectional views that show a percolator-type disposable coffee maker in accordance with a still further embodiment.

### DETAILED DESCRIPTION

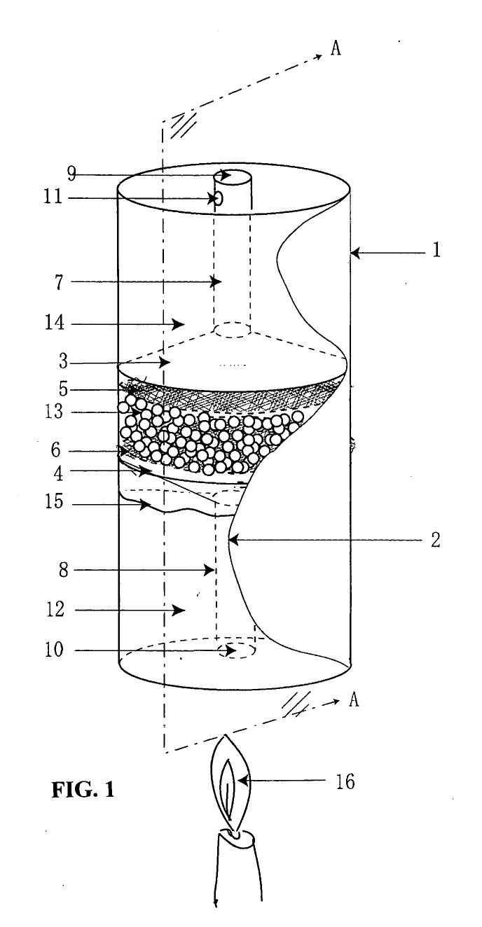

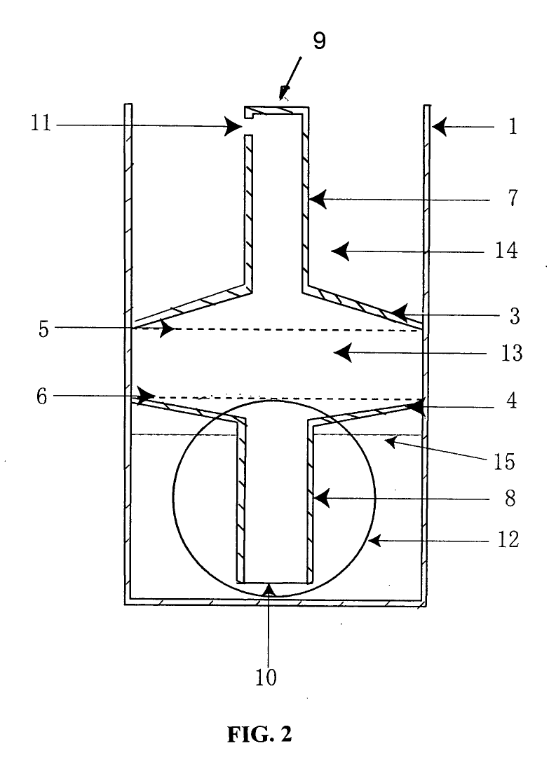

Referring to FIG. 1, and FIG. 2 which is a cross-sectional view taken along line A-A of FIG. 1, a description is given of a version of the present invention. The inside of a metal can 1 is separated into three sections, namely, a lower section 12 having a bottom, a center section 13 and an upper section 14, by upper and lower funnel-shaped members 3, 4. The funnel-shaped members 3, 4 are arranged so that larger opened ends are allowed to face each other. On the side opposite to the larger opened side of the lower funnel shaped member 4 is a “leg portion” referred to as a boiling water transmission pipe 8. The similar shaped upper-side member on the upper funnel shaped member 3 is referred to as an extracted coffee discharge pipe 7. The tip 9 of the extracted coffee discharge pipe 7 is closed, and an extracted coffee discharge hole 11 is formed in the vicinity thereof. The tip of the boiling water transmission pipe 8 in this version is plugged by a thin film valve 10 that is openable by heat or pressure. The peripheral portion of each of the opened sides of the funnel-shaped members 3 and 4 is secured through thermal sealing in order to join coffee filters 5 and 6 thereto. A section enclosed by the bottom of the metal can 1 and the sides of the funnel-shaped member 4, i.e., the lower section 12, is at least partially filled with water. Reference numeral 15 in FIG. 1 denotes the upper edge of water. The center section 13, which is sandwiched by two sheets of the coffee filters 5, 6 holds ground coffee beans.

When the bottom of the can 1 is heated by a heat source 16, the water in the lower section 12 is heated to a boil, so that the inner pressure of the lower section 12 increases. The boiling water causes the film valve 10 to open, and the water reaches the center section 13 through the boiling water transmission pipe 8 and permeates into the ground coffee beans held in the center section. Thus, coffee is extracted and filtered through the coffee filter 5 and discharged through the extracted coffee discharge pipe 7, through the discharging hole 11 and is accumulated in the upper section 14 from which the coffee can be obtained.

By attaching the film valve 10 to the lower end of the boiling water transmission pipe 8, it is possible to prevent water from entering the center section 13 and reaching the ground coffee beans during transportation. In the case where the film is formed by a material that has a small permeability to oxygen and water vapor, it becomes possible to keep the ground coffee beans in a deoxidized state or a dry state to preserve the ground coffee beans for a long time. The upper section 14 is sealed by using an appropriate material. The plugging of the tip of each of the extracted coffee discharge hole 11 and the extracted coffee discharge pipe 7 is made by using a normal easy-peeling method that allows peeling with hands.

As shown in FIG. 3, with respect to the attaching method for the film valve 10, it is secured to the lower-end cross section of the boiling water transmission pipe 8 by using a heat-resistant hot-melt or an adhesive 17. When water is heated to boil and the temperature and the inner pressure increase, the film valve 10 breaks, an opening is made as indicated by the film valve 10 as shown in FIG. 4, and boiling water is allowed to pass up the pipe 8. With respect to the material for the film, for example, materials such as polyolefin, polyester and rubber are suitable.

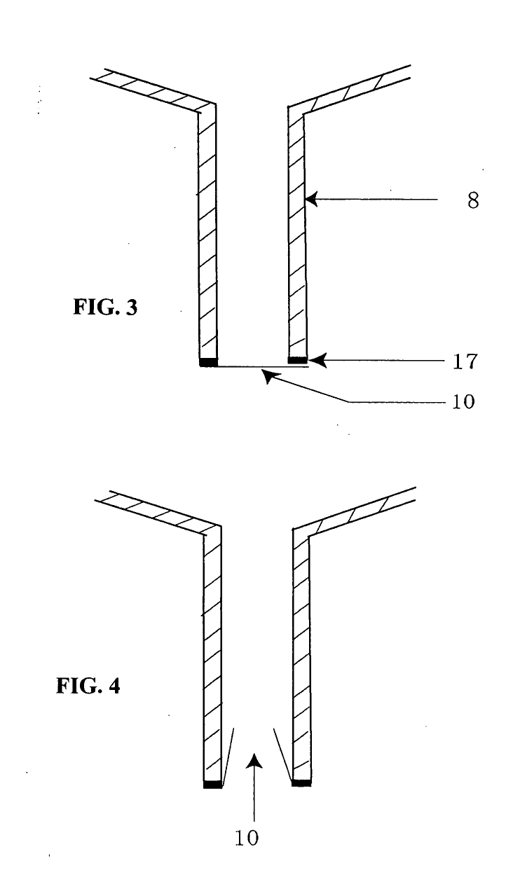

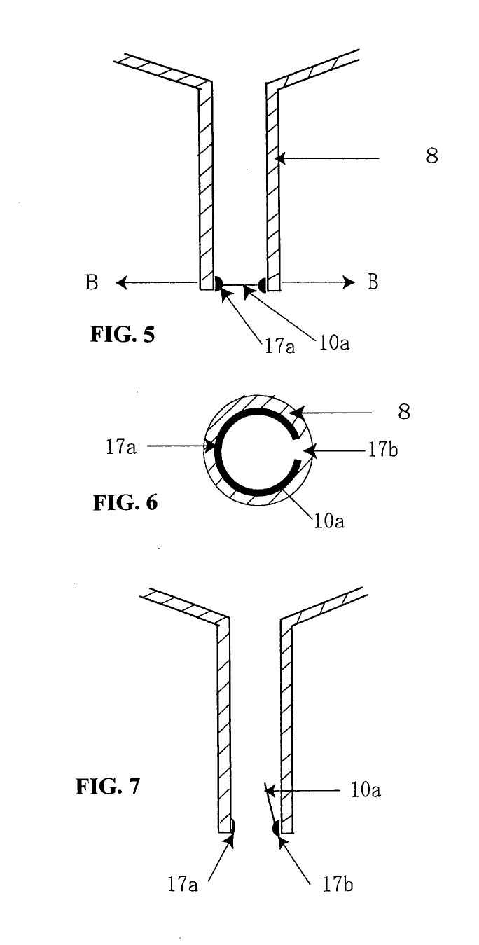

If the film valve 10 is made of metal or a ceramic film, it has an extremely low permeability to oxygen and water vapor, so that it is suitable for preservation of the ground coffee beans. However, since the film material of this type is difficult to break by application of heat and a pressure, it is necessary to provide a different attaching method. For example, an attaching method as shown in FIG. 5 and FIG. 6 which is a cross-sectional view taken along line B-B of FIG. 5 is suitable. Most of the peripheral portion of the round film valve 10a (FIGS. 5-7) is secured to the inner side face of the boiling water transmission pipe 8 by using a hot-melt or an adhesive 17a that is softened by boiling water (indicated by a bold line in FIG. 6), and one portion of the hot-melt securing portion is secured by the hot-melt 17b that is not melted by heat. When water is allowed to boil, the hot-melt 17a, having a low melting point, is softened by the boiling water so that the film valve 10a is released with the adhesive 17b, having a higher melting point, remaining to serve as a hinge. Therefore, the film valve 10a opens like a door (FIG. 7).

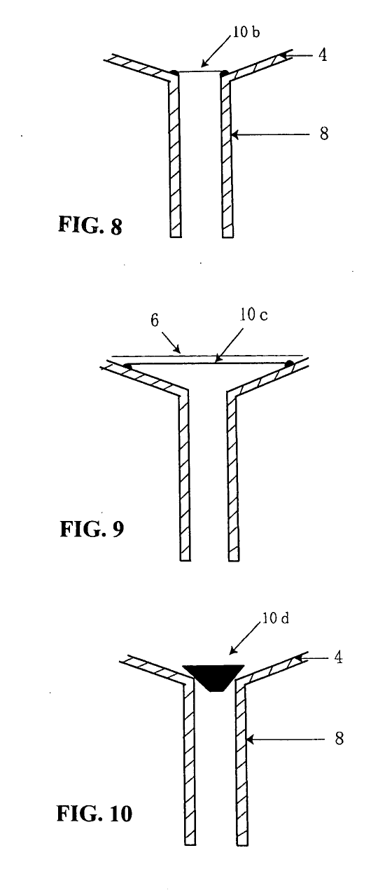

With respect to the position where the film valve is attached, alternate locations may be used. The attaching position can be on the upper portion (10b) of the boiling water transmission pipe 8 as shown in FIG. 8 or at a second position 10c right below the coffee filter 6, as shown in FIG. 9. The securing methods for these are the same as those shown in FIGS. 3 and 4.

Alternatively, the film valve may have a plug 10d (FIG. 10), which is attached to the upper portion of the boiling water transmission pipe 8. In this case, different from a film, the plug 10d is not thin so that the water vapor permeability is not so important. Therefore, with respect to the material, selection can be made from many materials such as plastic, metal, ceramics, glass and rubber.

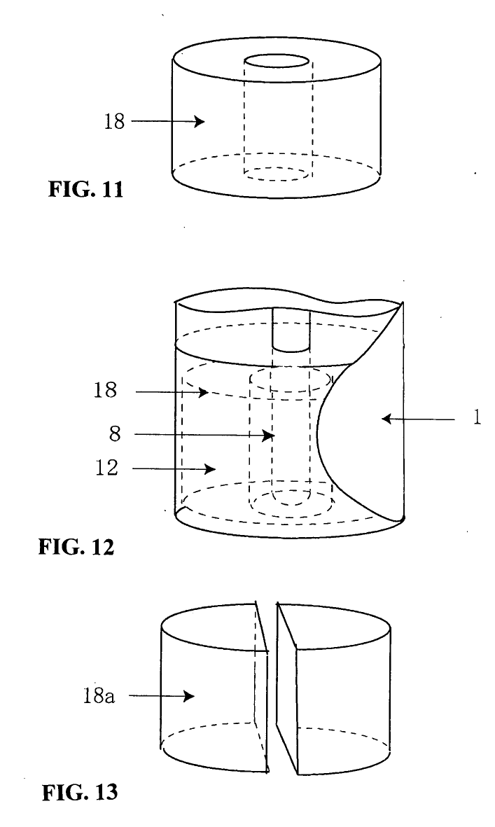

With respect to the method for storing water, in addition to a method in which water is directly stored in the lower section 12 of the metal can 1, another method is proposed in which a container made of a thermoplastic material is filled with water sealed therein in a separate manner to form a water tank housed in the lower section 12 of FIG. 1. FIG. 11 is a view that shows a concentric cylinder-type water tank 18, and FIG. 12 is a partial cross-sectional view that shows the water tank 18 housed in the lower section 12 of the metal can 1 of FIG. 1.

When the bottom of the metal can 1 is heated, the tank 18 melts and breaks releasing water that is made to boil. Not limited to the concentric cylinder shape, the tank may be formed as two semi-cylindrical water tanks 18 as shown in FIG. 13 and various other shapes as may also be proposed. The advantage of the use of the water tank is that, in the case when the material is olefin-based plastic no film valve, used for blocking oxygen and water and described with reference to FIGS. 3-10, is required. The manufacturing process for preparing the water tank is carried out by using conventional manufacturing lines, so that the manufacturing processes for the present invention can be simplified.

The upper section 14 in which the extracted coffee is stored also serves as a cup. If this is made of metal, it becomes too hot to drink the coffee from this portion, therefore, only the upper section 14 may be made of plastic.

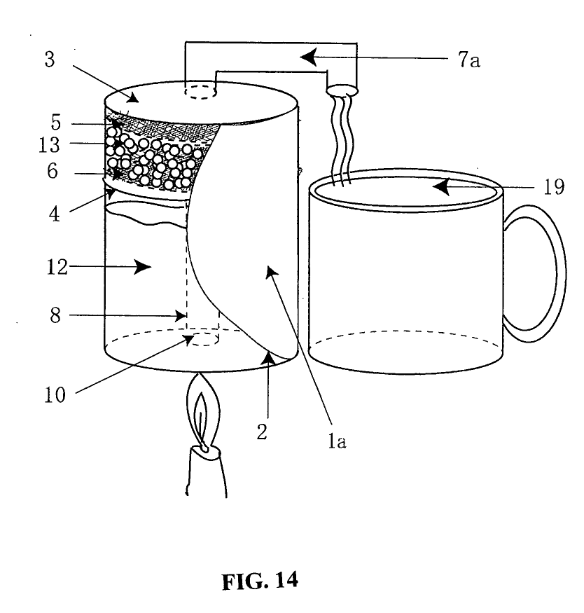

Moreover, the upper section 14 may be separated from the metal can 1. When the upper section 14 of FIG. 1 is removed to change the extracted coffee discharge pipe 7 into a pipe of bent shape 7a having the same functions, shown in FIG. 14, the extracted coffee is poured into a cup 19 placed at the outlet thereof through the pipe 7a.

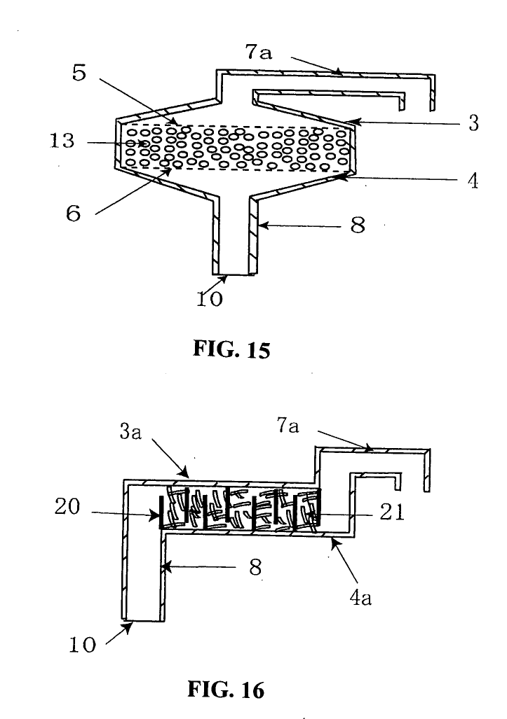

In FIGS. 1 and 14, both of the funnel-shaped member 3 on the upper side and the funnel-shaped member 4 on the lower side are directly secured to the can so that the lower section 12, the center section 13 and the upper section 14 are formed. After the funnel-shaped member 3 on the upper side and the funnel-shaped member 4 on the lower side have been preliminarily joined to each other to form a single container having a ground coffee beans storage section, the single container is fitted to the metal can 1 of FIG. 1 or the metal can 1a of FIG. 14; thus, the manufacturing processes are further simplified. Various structures and shapes for the container have been proposed, and a container having a structure as shown in FIG. 15 forms a typical example.

In the example shown in FIG. 16, many small partition plates 20 are alternately attached to the inside faces of the funnel-shaped member 3a on the upper side and the funnel-shaped member 4a on the lower side, and ground coffee beans 21 are placed between these partition plates.

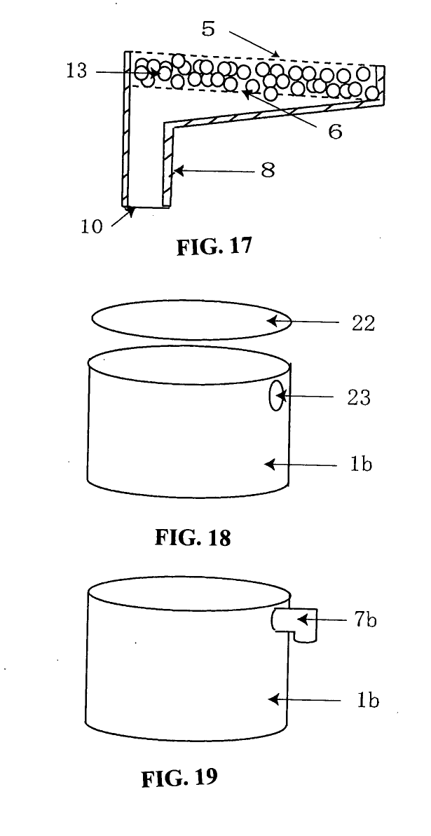

FIG. 17 shows an example of the container having a simpler structure. Two coffee filters are secured to a funnel-shaped member with ground coffee beans being stored therebetween. In a separated manner, a metal can 1b is formed having a small hole 23 below a flange to be used for seaming a lid 22 (FIG. 18). The container in which the ground coffee beans are stored (FIG. 17) is housed in this can, and the lid 22 is seamed thereon. Upon making coffee, an extracted coffee discharge pipe 7b is inserted into the small hole 23 so that coffee is discharged from this pipe.

The above description describes an espresso-type coffee maker.

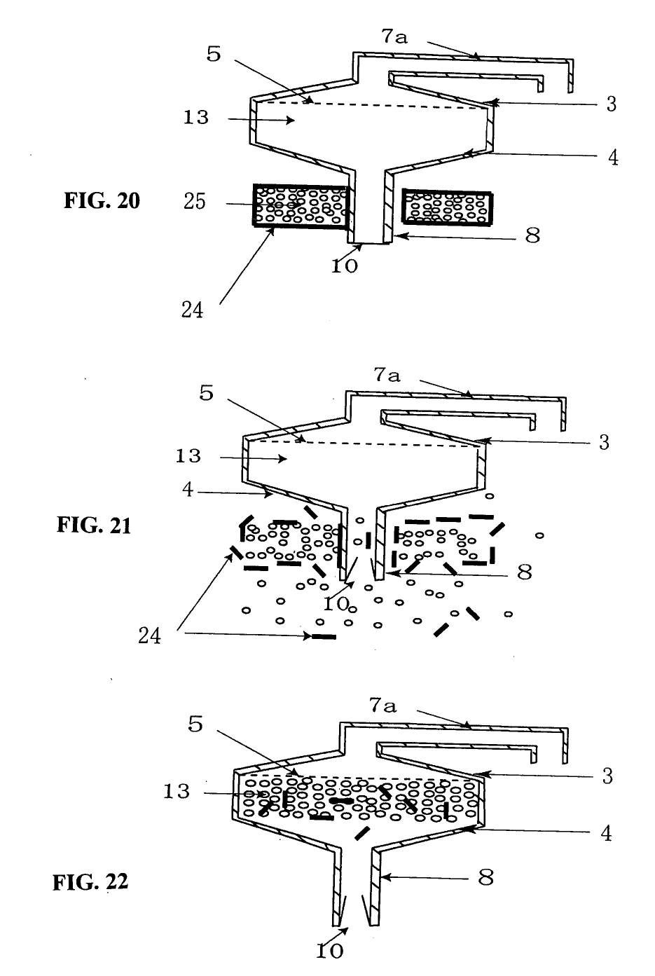

Next, a percolator-type coffee maker is described. Instead of placing the ground coffee beans in section 13 as shown in FIG. 15, they are packaged in a separate container 25 made of a material 24 that is breakable through heat, as shown in FIG. 20. This package is housed in a section 12 of a metal can which stores water. Here, the container 25 may be secured to the metal can 1 or the like, or may be floated on water. When water is allowed to boil, heat softens the material 24 so that the container 25 is broken; thus, the ground coffee beans are suspended in the hot water and allowed to enter the boiling water transmission pipe 8 through the film valve 10 that has been broken by heat.

FIG. 21 shows this state (the broken container 25). FIG. 22 shows a state where the hot-water suspension of the ground coffee beans is pushed up to the section 13 and the extraction residue is filtered through the coffee filter 5. The filtrate is discharged out of the system as extracted coffee through the discharging pipe 7a.

In recent years in the field of beverages such as coffee and tea, there have been increasing demands for good flavor as well as for having those hot beverages prepared in the field in a short time. With respect to the latter demands, extraction dried powder and canned beverages have been developed so that it becomes possible to have so-called instant coffee and canned coffee easily in the field. However, the main problem with these is that the flavor thereof is inferior to that of coffee or tea made through these prior methods.

With respect to the method for making coffee in the present invention, water is allowed to boil, and normal ground coffee beans are extracted on demand. Therefore, there is no difference from the prior techniques for making coffee. Thus, the resulting flavor is of course superior to that of the instant coffee or canned coffee. The most important factor is how to store the ground coffee beans in the can at normal temperature for a long time without impairing the flavor, preferably by limiting exposure to oxygen and humidity.

In the structure of the present invention shown in FIGS. 1 and 14, the ground coffee beans are stored between the funnel-shaped members 3 and 4 on the upper and lower sides. Therefore, the material of construction needs to have as small a permeability to oxygen and water vapor as possible. Moreover, it also needs to have a high heat-resistant property to boiling water. For example, various materials such as metal, various plastics, particularly biodegradable plastics are proposed as the material. In particular, metal is the most suitable, however, from the viewpoints of mass production and costs, a combination of various plastics and a multilayered plastic structure are practically used. With respect to the materials for the storage portions of the ground coffee beans shown in FIGS. 14-22, the same materials are adopted.

The material for the coffee filters 5 and 6 to be used for filtering the ground coffee beans needs to have at least a heat-resistant property, and commercially available filters, which are made from spinning fibers of polypropylene, polyester or cellulose and other plastics which allow melt-sealing, may be utilized.

With respect to the material for the film valve 10 that is broken when water boils, those materials which are thermally melted by boiling water in the lower section 12 or are breakable upon an increase in the inner pressure of the lower section 12, and have a small permeability to oxygen and water vapor as possible are preferred. With respect to the film valves 10 and 10a shown in FIGS. 3-9, a plastic film is preferably used. With respect to the material thereof, in addition to olefin-based plastics, metal and films made of silica-vapor-deposition plastic may also be used.

With respect to the material that has an extremely small permeability to oxygen and water vapor, films made of metal and ceramics are preferably used, and with respect to the attaching method for the material, a method shown in FIG. 5-7 is preferably used. A combination of a hot-melt material that is softened by boiling water and a hot-melt material that is not softened by boiling water, or a combination between a hot-melt material and an adhesive, is also proposed. The same is true for the adhesive.

As shown in FIG. 6, in the case where water is enclosed in a container that is melted and broken through heat, application of the container being housed in a metal can 1, with respect to the material for the container, in addition to a container made of plastics that is thermally melted by boiling water, a metal or ceramic container which is assembled by using a hot-melt that is thermally melted by boiling water and an adhesive, may also be used. When the material has sufficiently low permeability to oxygen and water vapor, it is not necessary to provide the film valve 10. However, in the case where the permeability is insufficient, a film valve made from an appropriate material is required as described above.

With respect to a method for separating the ground coffee beans from oxygen, water to be stored can be preliminarily subjected to a degassing process.

Also in the case of the percolator-type coffee maker, the material of the container used for storing the ground coffee beans may be of the same material as that used for the water tank.

In the present invention, since both of water and coffee are stored together, the system requires only a heat source for heating water to boil. With respect to various portable fuels, portable heaters and portable burners, those which are commercially available may be readily attached and utilized. Here, a heat source is preliminarily attached to the bottom of each of the metal cans 1 and la; thus, the device is more conveniently used. The material of the bottom of the can that is directly in contact with the heat source is preferably metal or ceramics; however, it is only necessary for the side faces and the inner faces of the can to resist boiling water so that various heat-resistant plastic materials may be used for the materials for these members.

In place of the ground coffee beans, the present invention may be used for any foodstuff, such as green tea, tea, oolong tea and herb tea, as long as it is extracted through boiling water.

### EXAMPLES OF THE PREFERRED EMBODIMENTS

### Example 1

FIG. 1 shows a first embodiment of the present invention. A metal can (diameter: 70 mm, height: 125 mm) is separated by two polypropylene funnel-shaped members (thickness: 0.5 mm, inner diameter of leg portion of funnel: 9 mm) into three sections—a lower section 12, a center section 13 and an upper section 14. A coffee extraction mesh filter (150 mesh, made of polypropylene) was joined and secured to the opened side of each of the funnel-shaped members through a thermal sealing process. The lower section 12, which stores water, has a height of 45 mm, with 150 ml of water placed therein. With respect to the method of placing the water, a hole was formed in an upper portion of the side face of the lower section 12 and, after having injected water through the hole, the hole was tightly sealed by using a heat-resistant hot-melt material. The center section 13 had a height of 15 mm, 10 g of normal ground coffee beans being stored therein. The upper section 14, in which extracted coffee is accumulated, has a height of 40 mm. An ultra-low density polyethylene film (softening point: 40° C., thickness: 0.03 mm) was thermally melt-adhered to the leg portion of the funnel 15 on the lower side, that is, to the lower end of a boiling water transmission pipe 8, as a film valve 10.

When the bottom of the finished product of the present invention was heated by using an outdoor-use alcohol fuel for about 3 minutes, water boiled, so that 130 ml of coffee was then extracted and accumulated in the upper section 13.

### Example 2

FIG. 11 shows an embodiment in which the storing method for water in the lower section 12 of FIG. 1 is different. A concentric cylinder-type tank 18 shown in FIG. 11 (outer diameter: 60 mm, inner diameter: 15 mm, height: 40 mm) was manufactured through a thermal sealing method, by using low-density polyethylene films (thickness: 0.03 mm), and this tank was housed in the lower section 12 of FIG. 1. The storing method for the ground coffee beans, etc. was the same as that for the first example. However, film valve 10 at the lower end of the boiling water transmission pipe 8 is omitted.

In the same manner as the first example, when the bottom thereof was heated by using an outdoor-use alcohol fuel, the bottom of the polyethylene film tank 18 storing water was broken by heat immediately, so that water was allowed to boil in 3 minutes. One 110 ml of coffee was extracted and accumulated in the upper section 13.

### Example 3

FIG. 20 shows a third embodiment of the present invention. The same ultra-low density polyethylene film material that was used for film valve 10 of the first embodiment was used to manufacture two rectangular parallelepiped containers 25 (25×30×20 mm) as shown in FIG. 20, and 10 g of ground coffee beans were enclosed therein. These were housed in the lower section 12 of FIG. 14 together with water (150 ml). Only the container of FIG. 20 was inserted into the can 1a of the coffee maker of FIG. 14. In this case, of course, only the can 1a of FIG. 14 was used, and the other components were unnecessary. In the same manner as the first example, water boiled in 3 minutes when the bottom of the can was heated by using an outdoor-use alcohol fuel, and the polyethylene container storing the ground coffee beans was immediately broken through heat so that the ground coffee beans were suspended in the boiling water. The suspension was raised through the boiling water transmission pipe 8 and filtered by the coffee filter 5 secured to the funnel-shaped member 3 on the upper side, so that the residue of the ground coffee beans was filtered and separated between the coffee filter 5 on the upper side and the funnel-shaped member 4 on the lower side. The filtrate was accumulated in a cup 19 as extracted coffee, through the pipe 7a. The amount was 130 ml.

1. A disposable device for forming a hot liquid comprising a container wherein the inside of the container is separated by lower and upper barriers into at least a lower section and an upper section connected to each other through a pipe or water passage in the lower barrier, with an extractable food stuff being positioned above the lower section and lower barrier,
so that water located in the lower section, when heated to boiling by an external heat source applied to the bottom of the lower section, creating an elevated pressure in the lower section, will move through the pipe or water passage and the extractable food stuff to the upper section,
the water in the lower section being excluded from entering the extractable food stuff by a partition wall on or in the pipe or water passage extending into the lower section, the partition wall being opened by heat or pressure provided by the heated water, allowing the water to move through the pipe or water passage and the extractable food stuff to the upper section.

2. The disposable device of claim 1 wherein the partition wall is a film or a sheet of a plastic, metal, ceramic, glass or rubber material or is a plug made of such a material.

3. The disposable device of claim 1 wherein the bottom of the container is formed of a heat-resistant metal or ceramic material.

4. The disposable device of claim 1 wherein the pipe or the water passage in the lower barrier extends into the lower section and has a lower end adjacent the bottom of the lower section so that elevated pressure in the lower section will move substantially all of the water in the lower section to the upper section.

5. The disposable device of claim 1 wherein a second pipe or water passage extends above the stored extractable foodstuff so that hot water passing through the extractable foodstuff is carried outward through the second tube or water passage and is prevented from returning to the lower section.

6. The disposable device of claim 1 wherein the extractable food stuff is ground coffee beans, tea, green tea, herbs, herbal medicine or a soup mix.

7. The disposable device of claim 1 wherein a filter is placed in the vicinity of an inlet to the second pipe or water passage so that the extractable food stuff is retained below the second pipe or water passage while soluble material extracted from extractable food stuff passes through the filter and the second pipe or water passage.

8. A disposable device for forming a hot liquid containing an extractable component of a food stuff comprising a container wherein
the inside of the container is separated by a lower barrier into at least a lower section and an upper section connected to each other through a pipe or water passage in the lower barrier,
water located in the lower section, so that when heated to boiling by an external heat source applied to the bottom of the lower section an elevated pressure is created in the lower section, to the elevated pressure causing the heated water to move through the pipe or water passage to the upper section,
and an extractable food stuff being positioned in the lower section, the extractable food stuff being contained in a water impermeable container formed of a material opened by the heated water to allow the water to contact the extractable food stuff and an extractable component thereof to enter the heated water.

9. The disposable device of claim 8 wherein the extractable food stuff is ground coffee beans, tea, green tea, herbs, herbal medicine or a soup mix.

10. The disposable device of claim 8 wherein a filter is placed in the vicinity of an inlet to the second pipe or water passage so that the extractable food stuff is retained below the second pipe or water passage while soluble material extracted from extractable food stuff passes through the filter and the second pipe or water passage.

11. A disposable prepackaged coffee maker comprising ground coffee beans and water stored in a heatable container with the ground coffee beans isolated from the water until the water is heated to a selected elevated temperature, said prepackaged coffee maker including means for dispensing brewed coffee there from after the ground coffee beans therein have been extracted by said water following application of heat to said container.

12 The disposable prepackaged coffee maker of claim 11 wherein the ground coffee beans are separated from the water by a barrier openable when the water is heated to the selected elevated temperature.

13. The disposable prepackaged coffee maker of claim 12 wherein internal pressure created within the heatable container resulting from heating the water to a selected elevated temperature causes the heated water to flow through the ground coffee beans and into an upper space within the heatable container, said upper space including the means for dispensing brewed coffee there from.

14. The disposable prepackaged coffee maker of claim 12 wherein the barrier is a valve on or in a delivery tube positioned between a water storage space and a ground coffee bean storage space.

15. The disposable prepackaged coffee maker of claim 12 wherein the barrier is a plastic container formed of a thermoplastic material surrounding the ground coffee beans, said thermoplastic material melting at the selected elevated temperature to expose the ground coffee beans to the heated water.

16. The disposable prepackaged coffee maker of claim 12 wherein the barrier is a surrounds the ground coffee beans, said barrier having a thermoplastic portion meltable at the selected elevated temperature to expose the ground coffee beans within the barrier to the heated water.
